(19) United States
(12) Patent Application Publication
(10) Pub. No.: US 2024/0350919 A1
(43) Pub. Date: Oct. 24, 2024

(54) METHOD AND APPARATUS FOR CONTROLLING VIRTUAL OBJECT, DEVICE, STORAGE MEDIUM, AND PROGRAM PRODUCT

(71) Applicant: Tencent Technology (Shenzhen) Company Limited, Shenzhen (CN)

(72) Inventors: Hao LI, Shenzhen (CN); Wei Fan, Shenzhen (CN); Zhen Qiao, Shenzhen (CN)

(21) Appl. No.: 18/763,869

(22) Filed: Jul. 3, 2024

Related U.S. Application Data
(63) Continuation of application No. PCT/CN2023/096736, filed on May 29, 2023.

(30) Foreign Application Priority Data
Aug. 3, 2022 (CN) 202210928035.6

(51) Int. Cl. A63F 13/56; A63F 13/537

(52) U.S. Cl. CPC A63F 13/56; A63F 13/537

(57) ABSTRACT

Disclosed is a method for controlling a virtual object performed by a computer device. The method includes: displaying at least two skill controls sharing a same skill point set, the skill point set including at least two skill points, and each skill control corresponding to one skill group, each skill group including at least one skill; determining a target first skill point in the at least two skill points in response to an operation on a first skill control in the at least two skill controls; and controlling a first virtual object to cast a skill corresponding to the first skill point in the skill group corresponding to the first skill control. In this application, a skill group corresponding to skill points is set for each skill control, and a skill can be added without adding a skill control, thereby improving the diversity of skill casting without affecting a user experience.

### CROSS-REFERENCE TO RELATED APPLICATIONS

This application is a continuation application of PCT Patent Application No. PCT/CN2023/096736, entitled “METHOD AND APPARATUS FOR CONTROLLING VIRTUAL OBJECT, DEVICE, STORAGE MEDIUM, AND PROGRAM PRODUCT” filed on May 29, 2023, which claims priority to Chinese Patent Application No. 202210928035.6, entitled “METHOD AND APPARATUS FOR CONTROLLING VIRTUAL OBJECT, DEVICE, STORAGE MEDIUM, AND PROGRAM PRODUCT” filed with the China National Intellectual Property Administration on Aug. 3, 2022, both of which are incorporated herein by reference in their entirety.

### FIELD OF THE TECHNOLOGY

Embodiments of this application relate to the field of computer and Internet technologies, and in particular, to a method and apparatus for controlling a virtual object, a device, a storage medium, and a program product.

### BACKGROUND OF THE DISCLOSURE

A battle game is a game in which a plurality of user accounts compete in a same scene. In some embodiments, the battle game may be a multiplayer online battle arena (MOBA) game.

In a typical MOBA game, a user can control a virtual object to cast a skill in a virtual environment, and each virtual object has its own set of skills. For example, if a virtual object has a first skill, a second skill, and a third skill, three skill controls respectively corresponding to the three skills may be arranged on a user interface, and a user controls, by triggering a skill control, the virtual object to use a corresponding skill.

In the related art, if it is expected to control the virtual object to use combined skills, the three skills can only be simply combined, resulting in a small number of combinations of skill casting.

### SUMMARY

Embodiments of this application provide a method for controlling a virtual object and apparatus, a device, a storage medium, and a program product. The technical solutions are as follows:

According to an aspect of the embodiments of this application, a method for controlling a virtual object is provided, performed by a terminal device, the method including:
displaying at least two skill controls sharing a same skill point set, the skill point set including at least two skill points, and each skill control corresponding to one skill group, each skill group including at least one skill;
determining a target first skill point in the at least two skill points in response to an operation on a first skill control in the at least two skill controls; and
controlling a first virtual object to cast a skill corresponding to the first skill point in the skill group corresponding to the first skill control.

According to an aspect of the embodiments of this application, a computer device is provided, including a processor and a memory, the memory having a computer program stored therein, the computer program, when executed by the processor, causing the computer device to implement the foregoing method.

According to an aspect of the embodiments of this application, a non-transitory computer-readable storage medium is provided, having a computer program stored therein, and the computer program, when executed by a processor of a computer device, causing the computer device to implement the foregoing method.

The technical solutions provided in the embodiments of this application may include the following beneficial effects: It is supported that at least two skill controls share a same skill point set, and when a user performs an operation on a first skill control in the at least two skill controls, a target first skill point is determined from a skill point set, and the first virtual object is controlled to cast a skill corresponding to the first skill point in a skill group corresponding to the first skill control, so that a current skill corresponding to a currently triggered skill control is determined by a skill point. Therefore, when there are at least two skill points and at least two skill controls, there is a plurality of possible combinations of skill casting based on different skill point selections and different skill control selections, so that combinations of skill casting may be diversified, thereby improving combination flexibility and diversity of skill casting.

### BRIEF DESCRIPTION OF THE DRAWINGS

FIG. 1 is a schematic diagram of a solution implementation environment according to an embodiment of this application.

FIG. 2 is a schematic diagram of a user interface according to an embodiment of this application.

FIG. 3 is a schematic diagram of a user interface according to another embodiment of this application.

FIG. 4 is a schematic diagram of a user interface according to another embodiment of this application.

FIG. 5 to FIG. 9 are schematic exemplary diagrams of a user interface in the related art.

FIG. 10 is a flowchart of a method for controlling a virtual object according to an embodiment of this application.

FIG. 11 is a flowchart of a method for controlling a virtual object according to another embodiment of this application.

FIG. 12 is a flowchart of a method for controlling a virtual object according to another embodiment of this application.

FIG. 13 is a flowchart of a method for controlling a virtual object according to another embodiment of this application.

FIG. 14 is a block diagram of a method for controlling a virtual object according to an embodiment in the related art.

FIG. 15 is a block diagram of a method for controlling a virtual object according to an embodiment of this application.

FIG. 16 is a block diagram of a method for controlling a virtual object according to another embodiment of this application.

FIG. 17 is a block diagram of skill switching logic according to an embodiment of this application.

FIG. 18 is a block diagram of cooldown time (CD) switching logic according to an embodiment of this application.

FIG. 19 is a block diagram of a virtual object control apparatus according to an embodiment of this application.

FIG. 20 is a block diagram of a virtual object control apparatus according to another embodiment of this application.

FIG. 21 is a structural block diagram of a terminal device according to an embodiment of this application.

### DESCRIPTION OF EMBODIMENTS

To make objectives, technical solutions, and advantages of this application clearer, implementations of this application are further described below in detail with reference to the accompanying drawings.

First, terms involved in the embodiments of this application are briefly introduced.

Virtual environment: It is a virtual environment displayed (or provided) when an application runs on a terminal. The virtual environment may be a simulated world of a real world, or may be a semi-simulated semi-fictional three-dimensional world, or may be an entirely fictional three-dimensional world. The virtual environment may be any one of a two-dimensional virtual environment, a 2.5-dimensional virtual environment, and a three-dimensional virtual environment. In some embodiments, the virtual environment is further used for a battle between at least two virtual objects, for example, providing a battle environment for the at least two virtual objects. There are virtual resources available to the at least two virtual objects in the virtual environment. In some embodiments, the virtual environment may include a lower left corner region and an upper right corner region that are symmetrical. Virtual objects on two opposing camps occupy the regions respectively, and the objective of each camp is to destroy a target building, a fort, a base, or a crystal deep in the region of the component to win victory.

Virtual object: It is a movable object or an unmovable object in a virtual environment. The movable object may be at least one of a virtual human, a virtual animal, or an animated human character. The unmovable object may be at least one of a virtual building, a virtual plant, or a virtual terrain. In some embodiments, when the virtual environment is a three-dimensional virtual environment, the virtual object may be a three-dimensional virtual model. Each virtual object has a shape and a volume in the three-dimensional virtual environment, and occupies some space in the three-dimensional virtual environment. In some embodiments, the virtual object is a three-dimensional character constructed based on three-dimensional human skeleton technology. The virtual object wears different skins to implement different appearances. In some implementations, the virtual object may be alternatively implemented by using a 2.5-dimensional model or a two-dimensional model. This is not limited in this embodiment of this application. For example, the virtual object may be divided into a user-controlled virtual object and a non-user-controlled virtual object (for example, a server-controlled virtual object) based on different manners of controlling the virtual object. The user-controlled virtual object is an object that is movable in the virtual environment and that is controlled by a client. The server-controlled virtual object is a virtual object controlled by an automatic control algorithm or an artificial intelligence program on the client or the server. The server-controlled virtual object includes a movable object and an unmovable object in the virtual environment. For example, the unmovable object may respond to or affect an activity of the movable object. For example, the movable object may destroy the unmovable object, or when the movable object enters the unmovable object, the movable object enters an invisible state. For example, the virtual object in this application is a virtual object controlled by the client. For example, the virtual object in this application may be a virtual object controlled by another client or server.

MOBA game: It is an arena in which different virtual teams on at least two opposing camps occupy respective map regions in a virtual environment, and compete against each other using a specific victory condition as a goal. The victory condition includes at least one of the following: occupying a fort or destroying a fort of the opposing camp, killing virtual objects in the opposing camp, ensuring own survivals in a specified scene and moment, seizing a specific resource, or outscoring the opponent within a specified moment. The battle arena game may take place in rounds (that is, an arena game). The same map or different maps may be used in different rounds of the battle arena game. Each virtual team includes one or more virtual objects, for example, 1 virtual object, 2 virtual objects, 3 virtual objects, or 5 virtual objects. In some embodiments, the MOBA game is a game in which several forts are provided in a virtual environment, and users on different camps control virtual objects to battle in the virtual environment to occupy forts or destroy forts of the opposing camp. For example, in the MOBA game, the users may be divided into two opposing camps. The virtual objects controlled by the users are scattered in the virtual environment to compete against each other, and the victory condition is to destroy or occupy all enemy forts. The duration of one round of the MOBA game is from a moment at which the game starts to a moment at which the victory condition is met.

A user interface (UI) control is a control for a user to perform human-computer interaction displayed in a user interface. For example, the user may control the virtual object through the UI control, or implement a function on the client through the UI control. The UI control is any visual control or element that can be seen in a user interface of an application, for example, a control such as a picture, an input box, a text box, a button, or a label. Some UI controls may respond to an operation of a user, for example, a skill control for controlling a virtual object to cast a skill. The user may control the virtual object to cast the skill by triggering the skill control. The UI control involved in this embodiment of this application includes at least one of the following: a skill control, a displacement control, a system function control, or an evolution control (configured for triggering evolution of one skill to another skill).

Cooldown Time (CD): It may also be referred to as skill cooldown time, which is a time interval during which a skill may be used, that is, time required to wait for a skill to be cast again after the skill is cast.

Skill point: It is a resource configured for managing a number of times of skill casting. For example, n (for example, 2, 3, or the like) skill points may be used for indicating to cast n skills (the n skills may be different). In some embodiments, skill points are generated as time goes by, and several skill points may be stored. In some embodiments, the skill enters full cooldown time only after the skill point is consumed. In the presence of the skill point, the cooldown time of the skill changes.

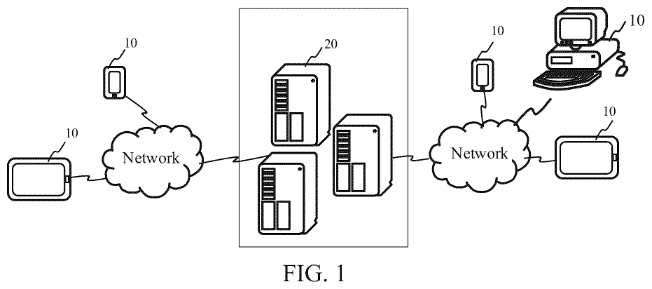

FIG. 1 is a schematic diagram of a solution implementation environment according to an embodiment of this application. The solution implementation environment may be implemented as a control system of the virtual object. The solution implementation environment may include: a terminal device 10 and a server 20.

The terminal device 10 may be an electronic device such as a mobile phone, a tablet computer, a game console, an ebook reader, a multimedia player, a wearable device, a personal computer (PC), an in-vehicle terminal, or an intelligent robot. A client of a target application (such as a game application) may be installed in the terminal device 10. In some embodiments, the target application may be an application that needs to be downloaded and installed, or may be a tap-to-use application. This is not limited in this embodiment of this application.

In this embodiment of this application, the foregoing target application may be any one of a simulation program, an escape shooting game, a virtual reality (VR) application, an augmented reality (AR) program, a three-dimensional map program, a VR game, an AR game, a first-person shooting (FPS) game, a multilayer shooting survival game, a third-person shooting (TPS) game, a MOBA game, a simulation game (SLG), a social application, or an interactive entertainment application. In this embodiment of this application, an example in which the target application is the MOBA game is used for description. In addition, virtual objects provided in different applications have different forms and corresponding functions, which may be preset based on an actual requirement. This is not limited in this embodiment of this application. In some embodiments, the client running the foregoing target application may be installed on the terminal device 10.

The foregoing virtual environment may be a scene displayed (or provided) when the client of the target application (such as the game application) runs on the terminal device. The arena game is used as an example. The virtual environment refers to a scene created for a virtual object to perform activities (such as game competition), such as a virtual house, a virtual island, or a virtual map.

The foregoing virtual object may be a virtual character, a virtual vehicle, a virtual item, or the like controlled by a user account in the target application. This is not limited in this embodiment of this application. For example, the target application is the MOBA game application. The virtual object may be a game character controlled by the user account in the game application. The virtual object may be in a human form, an animal form, a cartoon form, or another form. This is not limited in this embodiment of this application. The virtual object may be displayed in a three-dimensional form or a two-dimensional form. This is not limited in this embodiment of this application. In some embodiments, when the virtual environment is a 3D virtual environment, the virtual object is a 3D model created based on a skeletal animation technology. Each virtual object has a shape and size in the three-dimensional virtual environment, and occupies some space in the three-dimensional virtual environment. Activities of the virtual object include at least one of the following: adjusting body postures, crawling, walking, running, riding, flying, jumping, driving, picking, shooting, attacking, or throwing. For example, the virtual object is a virtual character such as a simulated character role or a cartoon character role.

The server 20 is configured to provide a backend service for the client of the target application installed and run on the terminal device 10. For example, the server 20 may be a backend server of the foregoing game application. The server 20 may be one server, a server cluster including a plurality of servers, or a cloud computing service center. In some embodiments, the server 20 provides backend services for target applications in a plurality of terminal devices 10.

In some embodiments, the terminal device 10 includes a first terminal device 11 (not shown in the figure) and a second terminal device 12 (not shown in the figure). The first terminal device is installed with a first client of the target application. The second terminal device is installed with a second client of the target application. A first user account of a first user controls a first virtual object in the first client of the target application. A second user account of a second user controls a second virtual object in the second client of the target application. In some embodiments, the first virtual object and the second virtual object are located in the same virtual environment. In some embodiments, the first virtual object and the second virtual object may belong to the same camp, the same team, or the same organization, have a friend relationship with each other, or have a temporary communication permission. In some embodiments, the first virtual object and the second virtual object may belong to different camps, different teams, or different organizations, or have a hostile relationship with each other. In some embodiments, the client installed on the first terminal device is the same as that installed on the second terminal device, or the clients installed on the two terminals are under different operating system platforms. The first terminal device may generally refer to one of a plurality of terminal devices, and the second terminal device may generally refer to another one of the plurality of terminal devices. In this embodiment, the first terminal device and the second terminal device are merely used as an example for description.

The terminal device 10 and the server 20 may communicate with each other through a network.

With reference to the foregoing description of the virtual environment and the description of the implementation environment, the method for controlling a virtual object provided by the embodiments of this application is described. Descriptions are made by using an example in which an execution body of the method is a client running on the terminal device shown in FIG. 1. The foregoing target application is installed and run on the terminal device. The target application can support the virtual environment.

For example, an example in which the method for controlling a virtual object provided by this application is applicable to the MOBA game is used.

First, a skill upgrading mechanism in the MOBA game is described. The virtual object in the MOBA game has a character level. The virtual object may upgrade the character level by obtaining an experience value. The experience value may be obtained based on battle time, the virtual object killing another virtual object, the virtual object killing a monster, or the like. When the character level of the virtual object is upgraded by one level, a skill upgrading opportunity may be obtained, and the virtual object may upgrade a skill. For example, an example in which the virtual object has three skills is used for description. When the battle starts, the character level of the virtual object is level 1. In this case, the virtual object has a skill upgrading opportunity. The user may upgrade any one of a first skill and a second skill. After the first skill or the second skill is upgraded, the virtual object obtains the skill. For example, when the battle starts, the user only upgrades the skill once to enable the virtual object to obtain the skill, so that the virtual object may use the skill. In other words, a virtual object with a level 1 can use only one skill. If two upgrading opportunities are used by a virtual object with a level 2 on two skills respectively, the virtual object may use the two skills. If the two upgrading opportunities are used on the same skill, the virtual object may still use only one skill. For example, the skill upgrading opportunity obtained by the virtual object at each level can only be used to upgrade one of the specified skills. For example, a level 1 to a level 3 may upgrade one of a first skill and a second skill, and a level 4 may upgrade one of a first skill, a second skill, or a third skill. After the virtual object upgrades a skill for the first time and obtains the skill, the virtual object may further continue to upgrade the skill. The upgrading may improve a value of some attributes of the skill. For example, the upgrading may improve at least one of action duration, an action distance, an action range, an attack value, a defense value, a shield value, or a size of a virtual object model of the skill. For example, the first skill may cause 100 points of physical damage to a hit virtual object and stunning the virtual object for 3 seconds before upgrading, and may cause 200 points of physical damage to a hit virtual object and stunning the virtual object for 6 seconds after upgrading. That is, the upgrading is only based on an original skill mechanism of the skill, and a value of the skill mechanism is changed, so that no new attribute is brought to the skill.

In an embodiment, the skill of the virtual object has a skill level, and the skill level may be increased by one level when the skill is upgraded for each time. When the virtual object has four skills, skill levels of the first skill, the second skill, and the third skill of the virtual object are up to a level 4, that is, the virtual object may be upgraded four times, and a skill level of a fourth skill is up to a level 3, that is, the virtual object may be upgraded three times. When the virtual object has three skills, skill levels of the first skill and the second skill of the virtual object are up to a level 6, that is, the virtual object may be upgraded six times, and a skill level of the third skill is up to a level 3, that is, the virtual object may be upgraded three times. When the skill level of each skill is greater than or equal to 1, the virtual object obtains the skill; or when the skill level of the skill is less than 1, the virtual object cannot use the skill, and a skill control corresponding to the skill is displayed in a gray state. A UI control in the gray state cannot receive a trigger operation of the user.

Based on the skill upgrading mechanism, this embodiment provides a skill evolution mechanism. The skill evolution mechanism may evolve a skill of the virtual object to another skill. For example, a skill of the virtual object before evolution is a first skill. After evolution is performed on the skill, the skill changes from a first skill to a second skill. The first skill and the second skill may be two completely different skills. The second skill may also be a skill obtained by improving the first skill and adding a new skill mechanism. For example, the first skill may cause 100 points of physical damage to a hit virtual object and stunning the virtual object for 3 seconds before evolution, and may cause 200 points of physical damage to a hit virtual object after evolution, stunning the virtual object for 6 seconds, and reducing a defense value of 50% of the virtual object for 3 seconds.

Based on the skill evolution mechanism, the embodiments of this application provide a skill group mechanism for skills. The skill group mechanism is that one skill control corresponds to a plurality of skills. In some embodiments, one skill control corresponds to at least two skills, and the virtual object may be controlled to cast different skills under different trigger conditions. For example, similar to in response to a touch or slide operation on a first skill control, when the virtual object meets a first condition, a first skill in a skill group corresponding to the first skill control is cast, and when the virtual object does not satisfy the first condition, a second skill in the skill group corresponding to the first skill control is cast. In some embodiments, the first condition is that the second skill corresponding to the first skill control of the first virtual object hits the second virtual object. In this case, when the first skill control is triggered again, the first virtual object casts the first skill corresponding to the first skill control. In some other embodiments, the plurality of skills corresponding to the first skill control are set in advance. When the first skill control is triggered for the first time, the first skill corresponding to the first skill control is cast, when the first skill control is triggered for the second time, the second skill corresponding to the first skill control is cast, and when the first skill control is triggered for the third time, the third skill corresponding to the first skill control is cast. A composition type of the skill group corresponding to the skill control is not limited in this embodiment of this application.

In some embodiments, a plurality of skills in the skill group are of the same attribute, for example, all are defense skills, and a skill group includes a plurality of different defense skills. In some embodiments, the plurality of skills in the skill group are of different attributes, for example, a skill with a defense attribute and a skill with an attack attribute in a skill group, for example, two skills with attack attributes and one skill with a defense attribute in a skill group. That is, when the first skill control is triggered, the client may control the virtual object to cast a skill with an attack attribute in the skill group corresponding to the first skill control, or may control the virtual object to cast a skill with a defense attribute in the skill group corresponding to the first skill control. Certainly, trigger conditions for different skills in the skill group are different.

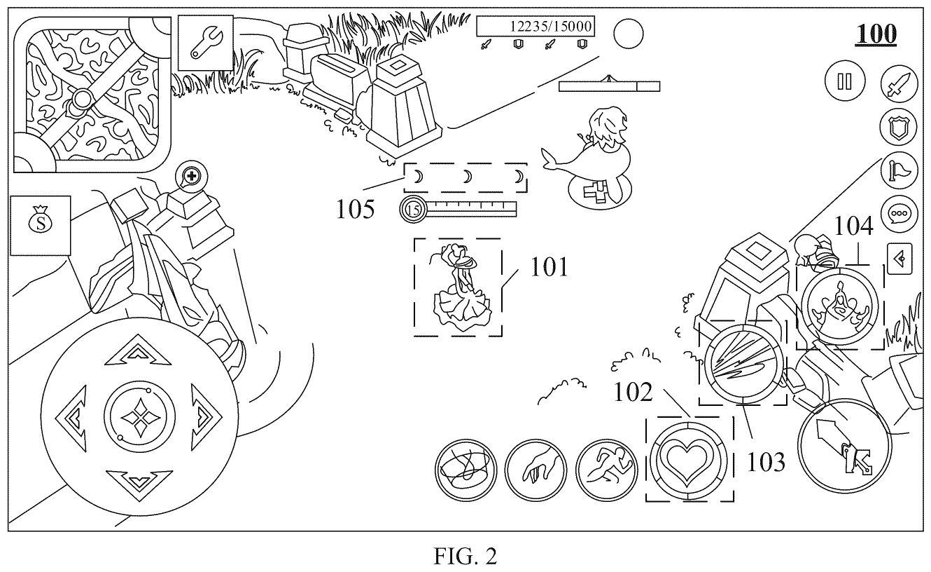

Based on the skill group mechanism, the embodiments of this application provide a combination mechanism for skills. In this embodiment of this application, a resource, a skill point, for managing a number of times of skill casting of the virtual object is provided. In some embodiments, several skill points may be stored. Referring to FIG. 2, a virtual object 101, a first skill control 102, a second skill control 103, a third skill control 104, and a skill point set 105 for indicating three skill points possessed by the virtual object 101 are displayed on a user interface 100. The skill points in the skill point set 105 may be consumed. When the virtual object 101 casts a skill corresponding to the first skill control 102, one skill point is consumed. In some embodiments, when the virtual object 101 casts a skill corresponding to the second skill control 103, skill points are also consumed. In some embodiments, when the virtual object 101 casts a skill corresponding to the third skill control 104, the skill points are not consumed (that is, the skill points are shared by the first skill control 102 and the second skill control 103, and are not shared by the third skill control 104). After the three skill points in the skill point set 105 are consumed, the user cannot perform a trigger operation on the first skill control 102 and the second skill control 103, that is, the first skill control 102 and the second skill control 103 are in an unselectable state, and the virtual object 101 cannot cast the skill corresponding to the first skill control 102 and the skill corresponding to the second skill control 103. However, the virtual object 101 may cast the skill corresponding to the third skill control 104 in response to a trigger operation on the third skill control 104 by the user.

In this embodiment of this application, the skill points in the skill point set 105 may further be restored after being consumed. In some embodiments, one skill control corresponds to one skill group. It is assumed that there are three skills in a skill group corresponding to the first skill control 102, namely bold A1, A2, and A3, three skills in a skill group corresponding to the second skill control 103, namely B1, B2, and B3, and the third skill control 104 corresponds to a skill C. For the virtual object 101 having three skill points, different skills may be cast in response to a trigger operation of the user. In some embodiments, when there are three skill points, if the user performs the trigger operation on the first skill control 102 or the second skill control 103, the virtual object 101 casts the A1 skill or the B1 skill. When only the second skill point and the third skill point remain after the first skill point is consumed, if the user continues to perform the trigger operation on the first skill control 102 or the second skill control 103, the virtual object 101 casts the A2 skill or the B2 skill. When only the third skill point remains after the second skill point is consumed, if the user continues to perform the trigger operation on the first skill control 102 or the second skill control 103, the virtual object 101 casts the A3 skill or the B3 skill. Therefore, for the virtual object 101 having the three skill points, a cast skill group corresponding to the first skill control 102 and the second skill control 103 may be at least one of A1A2A3, B1A2A3, A1B2A3, A1A2B3, B1B2A3, B1A2B3, A1B2B3, or B1B2B3.

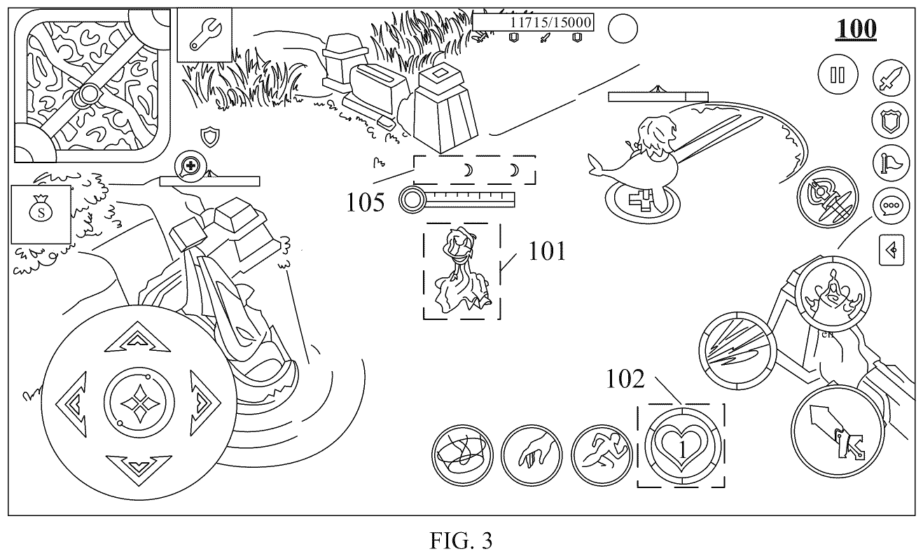

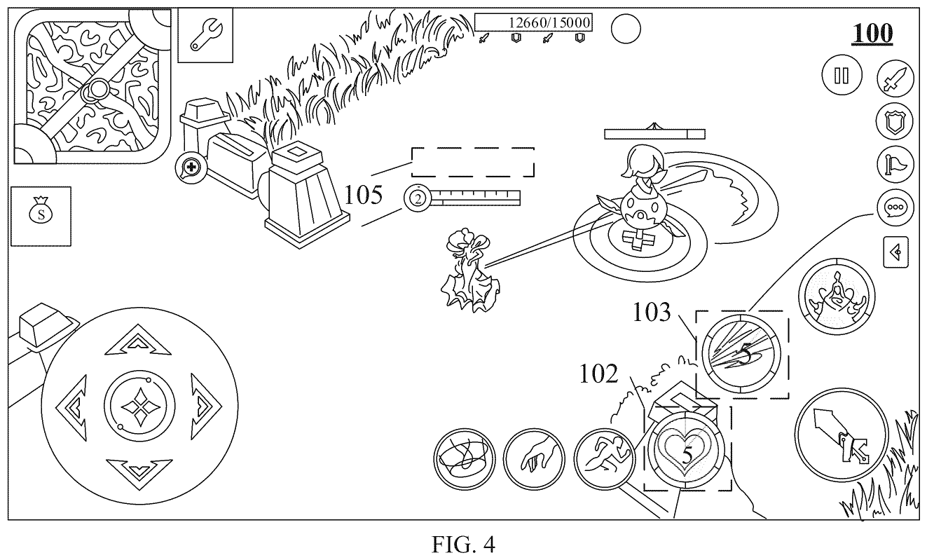

In this embodiment of this application, a number of skill points in the skill point set 105 is not limited, a combination form of consuming the skill point to cast the skill is not limited, and a number of skill controls corresponding to the skill that consumes the skill point is not limited. For example, skills in the skill group corresponding to three skill controls all consume the skill point when cast, or one or two of the skill controls consume the skill point when cast. Referring to FIG. 3, in response to a trigger operation on the first skill control 102 by the user, the client controls the virtual object 101 to cast the skill corresponding to the first skill control 102. In this case, the number of skill points in the skill point set 105 becomes two, and after the virtual object 101 casts the skill, the first skill control 102 enters a cooldown state. Referring to FIG. 4, when the skill points in the skill point set 105 are all consumed, both the first skill control 102 and the second skill control 103 enter the cooldown state (which may also be referred to as the unselectable state).

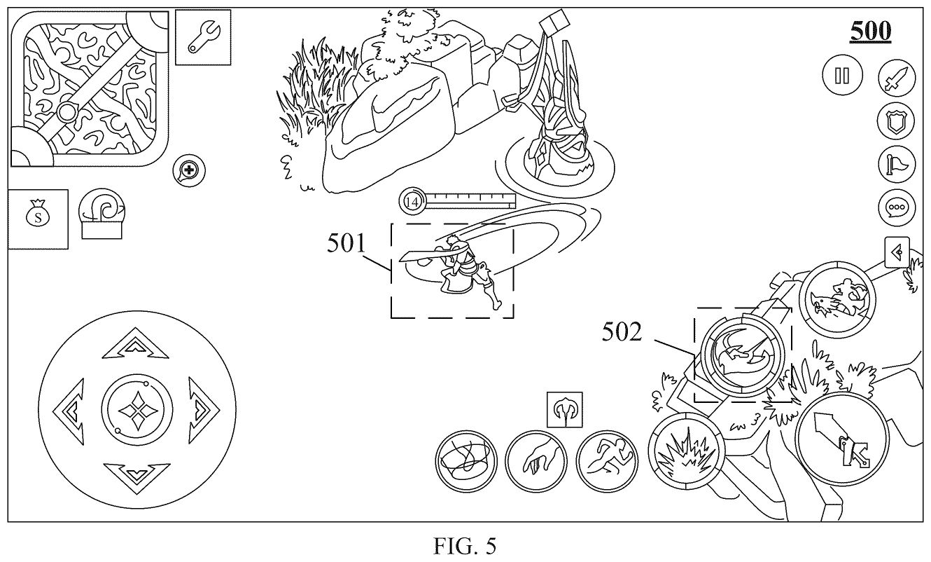

In the related art, a combination manner of some skills is also provided. In some embodiments, in a schematic diagram of a user interface 500 shown in FIG. 5, when a first skill corresponding to a second skill control 502 hits a second virtual object (not shown in the figure), a first virtual object 501 refreshes cooldown time of the second skill control 502. When the second skill control 502 is triggered again, the virtual object 501 is controlled to cast a second skill corresponding to the second skill control 502, where the first skill and the second skill corresponding to the second skill control 502 are different skills. The virtual object 501 may be controlled to cast the second skill only when a certain condition is satisfied. The second skill of the virtual object 501 is different from the first skill of the virtual object 501. In some embodiments, an attack value caused by the second skill increases by 25%.

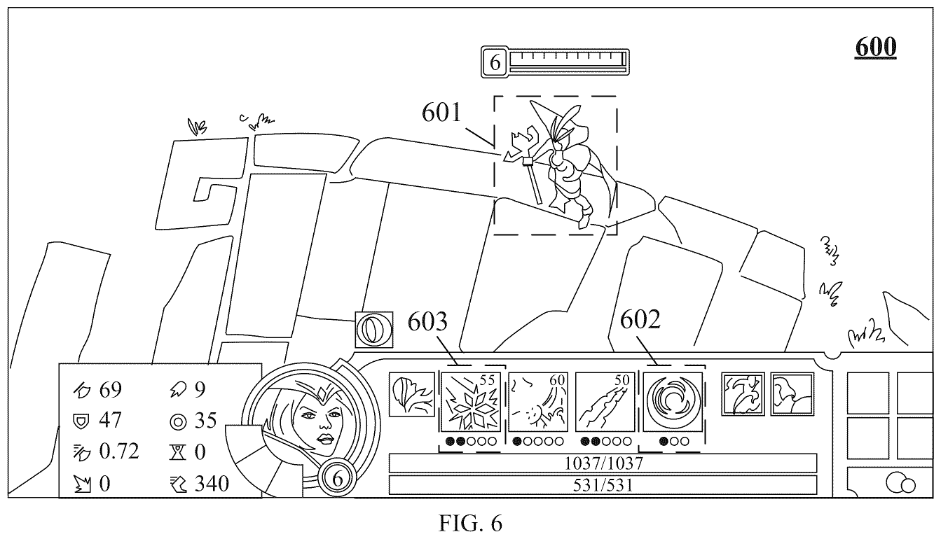

In some other embodiments, in a schematic diagram of a user interface 600 shown in FIG. 6, a fourth skill icon 602 is in an unusable state. In some embodiments, when a virtual object 601 casts a first skill corresponding to a first skill icon 603, a fourth skill corresponding to the fourth skill icon 602 may copy the first skill. In this case, a skill corresponding to the fourth skill icon 602 is the first skill corresponding to the first skill icon. Based on different skills cast by the virtual object 601, the fourth skill icon 602 may copy different skills.

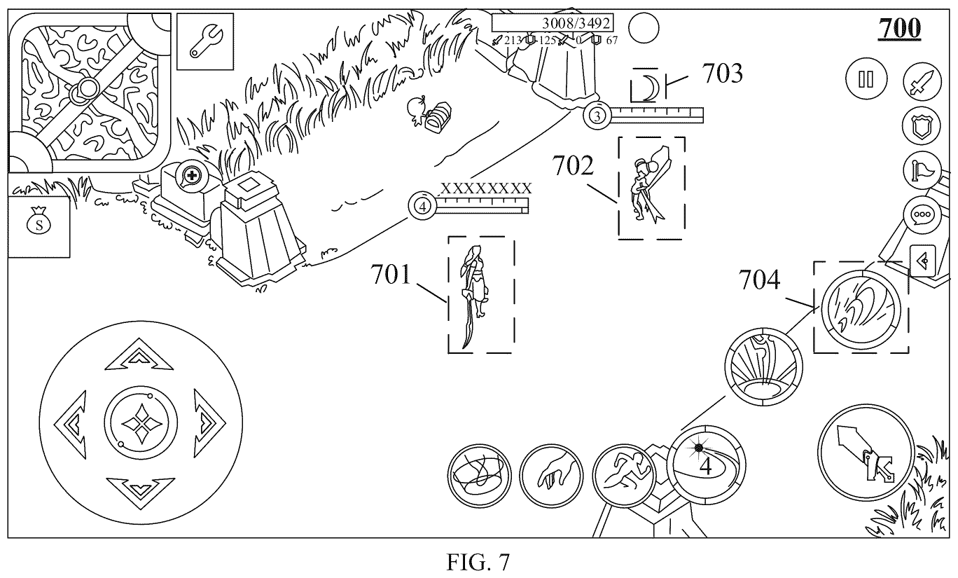

In some other embodiments, cooldown time of the skill is refreshed under a condition, for example, a specific skill is refreshed when another interaction condition existing in the game is reached, to implement a plurality of times of casting of the skill. These conditions may be that: a skill hits a target, defeats a target, casts a plurality of skills, hits a target with a specific mark, and the like. In a schematic diagram of a user interface 700 shown in FIG. 7, a first virtual object 701 casts a third skill, and the third skill hits a second virtual object 702. In this case, an identifier 703 for indicating that the second virtual object 702 is marked is displayed overhead of the second virtual object 702. In addition, based on the second virtual object 702 being marked, skill cooldown time of the third skill of the first virtual object 701 is adjusted to 0. That is, the first virtual object 701 may immediately cast the third skill in response to a trigger operation on a third skill control 704 by the user.

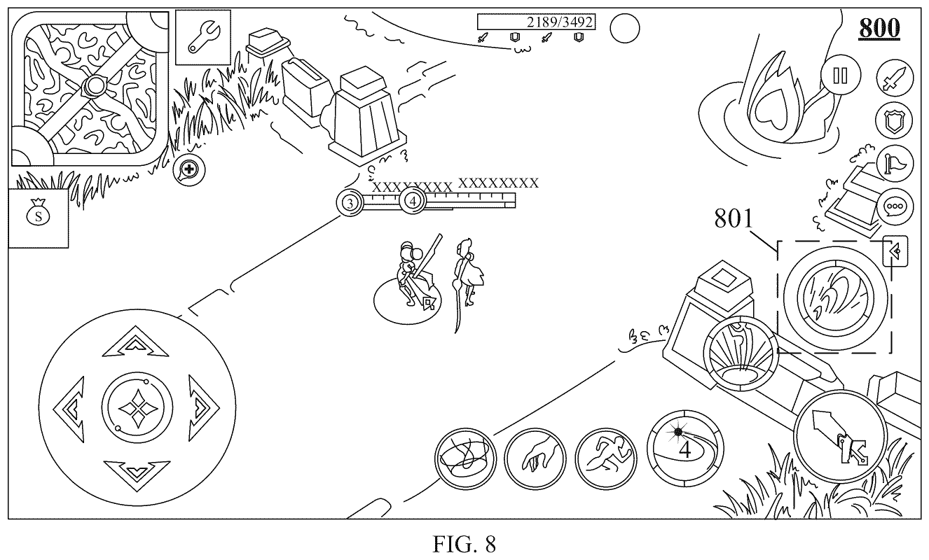

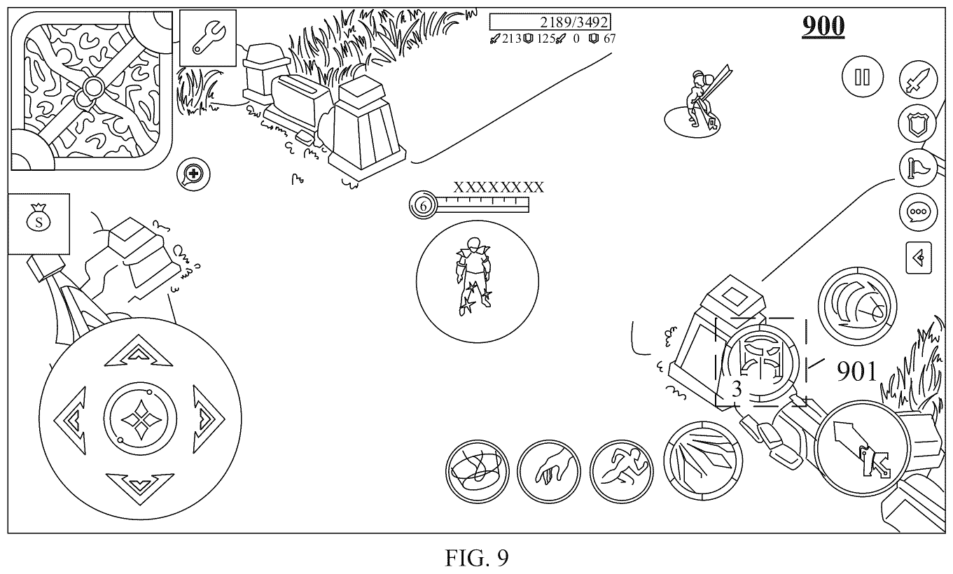

In some other embodiments, as shown in a schematic diagram of a user interface 800 shown in FIG. 8, a third skill control 801 is zoomed in and a plurality of third skills are stored at the same time. In other words, in response to a trigger operation on the third skill control 801 by the user, the virtual object may consecutively cast the third skill for a plurality of times. In some other embodiments, a skill is stored in a form of a skill bean. To be specific, a skill bean is set as a resource for a number of casts of a skill. When the skill bean is not consumed, the virtual object may cast the skill for a plurality of times, and the skill does not enter the CD or does not enter a complete CD. In a schematic diagram of a user interface 900 shown in FIG. 9, a number 3 is displayed on a second skill control 901, indicating that three second skills are stored. In other words, in response to consecutive trigger operations on the second skill control 901 by the user, the client may control the virtual object to consecutively cast the second skill for a plurality of times.

In the related art, a combination of skills is relatively simple. One is that another skill (which is essentially two stages corresponding to one skill) corresponding to the skill control appears when a condition is satisfied. However, if the skill is not cast within threshold time, it is no longer possible to continue to cast another skill this time. Alternatively, a skill is stored in a form of the skill bean. However, the skill is stored for the same skill. In other words, the virtual object may be controlled to consecutively cast the same skill for a plurality of times, but cannot cast different skills (which are essentially different stages corresponding to one skill). Therefore, the combination of skills in the related art is relatively simple.

Differently, the embodiments of this application provide a concept of the skill point. In some embodiments, there are three skill controls on the user interface. In response to an operation on the first skill control or on the second skill control, the skill point can be consumed to control the virtual object to cast the skill. In some other embodiments, the skill control that consumes the skill point corresponds to a skill group, and a plurality of skills are included in the skill group. In some embodiments, a total number of skill points is three, there are three different skills in the skill group, and the skills in the skill group correspond to the skill points. Therefore, for different skill points, the user performs different operations on the skill control, so that the virtual object may cast more different skill groups.

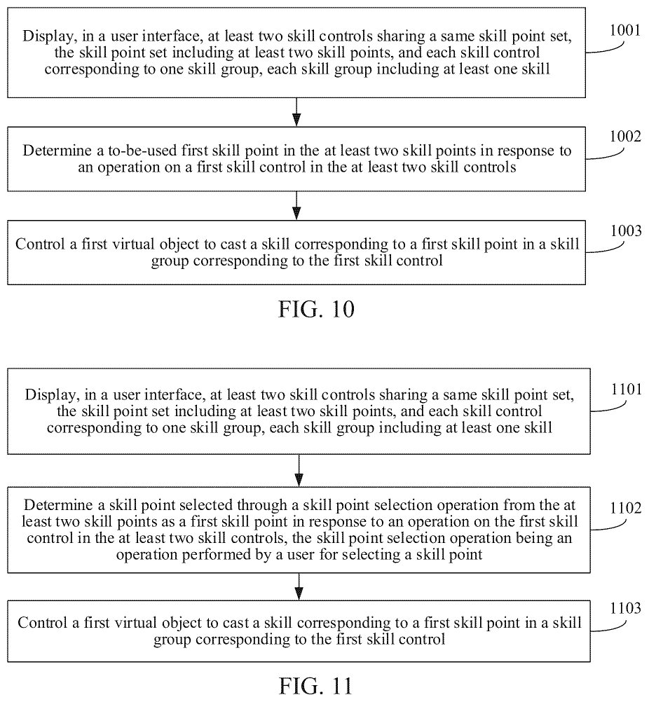

FIG. 10 is a flowchart of a method for controlling a virtual object according to an embodiment of this application. An execution body of each operation of the method may be the terminal device 10 in the implementation environment shown in FIG. 1. For example, the execution body of each operation may be the client of the foregoing target application. In the following method embodiments, for ease of description, the description is provided by merely using a “client” as the execution entity of each operation. The method may include at least one operation in the following operations (1001 to 1003):

Operation 1001: Display, in a user interface, at least two skill controls sharing a same skill point set. The skill point set includes at least two skill points, and each skill control corresponding to one skill group, each skill group including at least one skill.

The user interface refers to a user interface of the foregoing client, and may be configured for content display, providing a human-computer interaction service, and the like. For example, the user interface may be a user interface of the foregoing arena game, and may be configured to display a virtual environment picture corresponding to the arena game. In some embodiments, the user interface may include a display layer and a control layer. The control layer is located on an upper layer of the display layer. The display layer is configured to display content, and the control layer is configured to deploy a UI control.

Skill control: It is a control for casting a skill, for example, a UI control displayed on a user interface for controlling the virtual object to cast the skill in response to an operation by a user. A number of skill controls is limited to at least two in this application. In this way, a combination manner between skills may be increased, and fun of the arena is increased. A style, a layout, a size, and the like of the skill control may be set and adjusted according to an actual use requirement.

Skill group: It refers to a set of skills, for example, a set obtained by combining a plurality of different skills. The same skill control is shared by various skills in the skill group. For example, under different conditions, in response to an operation on the same skill control by the user, the client controls the virtual object to cast different skills. In some embodiments, in this embodiment of this application, a current skill point is used for indicating a skill to which a skill control currently corresponds. For example, for selection of different skill points, skills corresponding to the skill controls are different. In another example, for different number of skill points, skills corresponding to skill controls are different. This is not limited in this embodiment of this application.

Skill point set: It is a set including skill points, and a number of skill points in the skill point set changes. For example, each time the user consumes one skill point, the number of skill points in the skill point set is reduced. In some embodiments, when the skill points are all consumed, there are no skill points in the skill point set. In some embodiments, the skill points in the skill point set may restore over time. A display position and a display style of the skill point may also be set and adjusted according to an actual use requirement.

In some embodiments, there is at least one skill control in the at least two skill controls, and a skill group corresponding to the at least one skill control includes at least two skills. In some other embodiments, each skill group includes at least two skills. This is not limited in this application.

In some embodiments, a first skill group in skill groups corresponding to the at least two skill controls includes at least two skills, and different skills included in the first skill group correspond to different skill points.

The first skill group may refer to any skill group in at least two skill groups. In some embodiments, a number of skills in the first skill group may correspond to a number of skill points. If the skill point set includes 3 skill points, the first skill group may include 3 skills. The number of skills in the first skill group may be less than the number of skill points. If the skill point set includes 3 skill points, the first skill group may include 2 skills.

For example, a skill a1 and a skill a2 are in the first skill group, and the skill a1 and the skill a2 correspond to different skill points. For example, there are a total of two skill points in the skill group, namely a skill point 1 and a skill point 2. In some embodiments, the skill point 1 corresponds to the skill a1, and the skill point 2 corresponds to the skill a2. The skill point 1 may be configured for enabling the skill control corresponding to the first skill group to be configured to cast the skill a1. The skill point 2 may be configured for enabling the skill control corresponding to the first skill group to be configured to cast the skill a2. The skill point 2 does not correspond to the skill a1, and the skill point 1 does not correspond to the skill a2.

In some embodiments, a skill currently corresponding to a skill control may also be related to a current number of skill points in the skill point set. For example, when the current number of skill points in the skill point set is 2, the skill control corresponds to the skill a1; and when the current number of skill points in the skill point set is 1, the skill control corresponds to the skill a2.

In some embodiments, skills in a skill group are different. In some embodiments, skills in a skill group are of the same attribute. For example, skills in a skill group are of a defense attribute, or skills in a skill group are of an attack attribute. In some embodiments, skills in a skill group are of different attributes. For example, in a skill group, there are skills with an attack attribute and skills with a defense attribute.

For example, there is a difference in attack values between skills of the same attribute in a skill group. For example, an attack value caused by the skill a1 is 100, and an attack value caused by the skill a2 is 200. In some embodiments, there is a difference in defense values between skills of the same attribute in a skill group. For example, a defense value of the skill a1 to the virtual object is 100, and a defense value of the skill a2 to the virtual object is 200. In some other embodiments, different skills in a skill group may correspond to different forms of the virtual object. For example, the skill a1 may cause the virtual object to be in a first form, and the skill a2 may cause the virtual object to be in a second form. The first form and the second form are two different forms. A specific form may be at least one of a human form, an animal form, a walking form, a flying form, or the like. This is not limited in this application.

In the technical solutions provided in the embodiments of this application, a plurality of skills is arranged in the skill group, so that one skill control may correspond to one skill group, and one skill may be selected from the skill group as the skill currently corresponding to the skill control. When one skill control corresponds to one skill group, and the skill group includes at least two skills, the user may selectively control the virtual object to cast a skill in the skill group according to an actual situation. Therefore, more users can meet requirements, and there are more manners of controlling the virtual object and more manners of combining skill casting.

Operation 1002: Determine a target first skill point in at least two skill points in response to an operation on a first skill control in the at least two skill controls.

The first skill control may be any skill control in the at least two skill controls. In some embodiments, the first skill control may be selected by the user by using a touch device or a finger to target the first skill control on a display screen of a terminal device in which the client is located, or may be selected by the user by performing operation on the first skill control through an external device (such as a handle, a joystick, a mouse, or a keyboard). This is not limited in this embodiment of this application.

In some embodiments, the foregoing operation may be at least one of a tap operation, a slide operation, or a touch operation. This is not limited in this application. For example, in response to a tap operation on the first skill control by the user, the client determines the target first skill point in the at least two skill points.

A manner of determining the first skill point is not limited in this embodiment of this application. For example, one skill point may be randomly selected from the at least two skill points as the target first skill point. Alternatively, a current target first skill point, a next target first skill point, and the like may be determined in a front-to-back order. Alternatively, a current target first skill point, a next target first skill point, and the like may be determined in a back-to-front order. In some embodiments, the first skill point may alternatively be set by the user. For example, the first skill point under each operation is sequentially determined based on an order set by the user.

In some embodiments, the client determines the target first skill point in the at least two skill points based on a skill point use order. The skill point use order is configured to define a use order of the at least two skill points. The skill point use order may be set and adjusted by the user, or may be a fixed order preset by an application.

In some embodiments, if the skill point use order is from front to back/left to right, the skill points in the skill point set are sequentially selected from front to back/left to right. For example, referring to FIG. 2, the skill point set 105 includes three skill points, and the skill point use order is from left to right. After the first skill point is used in an order from left to right, a leftmost skill point in the skill point set 105 disappears, and the skill point set 105 is updated to the skill point set 105 as shown in FIG. 3 (only 2 skill points remain). An order in which the skill point is used is not limited in this application. In addition, a form of the skill points is not limited in this application. In the schematic diagram of the user interface 100 shown in FIG. 2 or FIG. 3, the skill point appears above a health bar of the virtual object 101 in a form of a moon. In some embodiments, the skill points may alternatively be displayed in another form such as a sun, a monster, a star, a number, or a lattice.

In some embodiments, the skill point may or may not be completely displayed on the user interface. For example, the user interface only displays the skill point control and does not display a specific number of skill points. The user needs to tap on the skill point control in which the skill point is located before all skill points can be fully expanded. In some other embodiments, the skill point may also not be displayed in the user interface at all. For example, a number of skill points is not displayed in the user interface at all, but there may be a voice broadcast, for example, “a user xxx obtains 3 skill points”. When the user uses the skill point, there is also a broadcast that “a user xxx uses the skill point 1, and 2 skill points remain”. In addition, a display position of the skill point in the user interface is not limited in this application. In some embodiments, the skill point is displayed in the virtual environment (that is, the display layer) in which the virtual object is located. In some embodiments, the skill point appears on a spatial layer of the user interface, and can be touched or tapped by the user.

In this embodiment of this application, a next to-be-used skill point is determined based on the skill point use order, so that the user may clearly determine the to-be-used skill point, and a skill to be controlled to cast by the virtual object is re-determined based on the to-be-used skill point, which is convenient for the user to understand the arena status in real time, and is very friendly to the novice user.

Operation 1003: Control a first virtual object to cast a skill corresponding to the first skill point in a skill group corresponding to the first skill control.

The first virtual object may be a virtual object controlled by a current user account logged in to the client in the terminal device. For the current terminal device, the first virtual object may also be referred to as a main virtual object in a current user interface corresponding to the current terminal device. The virtual object has been described in detail above, and details are not described herein again.

There is a correspondence between skills and skill points in each skill group. For example, the skills in the skill group are in a one-to-one correspondence with the skill points in the skill point set in an order. The correspondence between the skills in the skill group and the skill points may also be set by the user. The correspondence between the skills in the skill group and the skill points may also be random. This is not limited in this embodiment of this application.

For example, there are three skills in the skill group corresponding to the first skill control, and there are also three skill points in the skill point set. In response to the operation on the first skill control, if the first skill point in the skill point set is used, the client controls the first virtual object to cast the first skill in the skill group corresponding to the first skill control. In response to the operation on the first skill control, if the second skill point in the skill point set is used, the client controls the first virtual object to cast the second skill in the skill group corresponding to the first skill control. In response to the operation on the first skill control, if the third skill point in the skill point set is used, the client controls the first virtual object to cast the third skill in the skill group corresponding to the first skill control.

In some embodiments, the user interface displays an unused skill point in the at least two skill points. To be specific, the user interface displays the unused skill point, so that the user can know how many or which skill points are unused, or which skill points have been used, thereby improving user experience. For example, referring to FIG. 2, the three skill points included in the skill point set 105 are unused skill points. In another example, the two skill points included in the skill point set 105 in FIG. 3 are unused skill points.

According to the technical solutions provided in the embodiments of this application, the unused skill point in the skill point is displayed, so that a prompt may be effectively given to the user to inform the user of the unused skill point. Therefore, the user may determine which skill needs to be cast more accurately, which facilitates the operation of the user.

In some embodiments, the client displays an icon of a skill corresponding to a next used skill point in a display region of the skill control. For example, after the first skill point is used, if a next to-be-used skill point is the second skill point, the skill corresponding to the first skill control and the skill corresponding to the second skill control are changed. If the skill corresponds to the second skill point, the first skill control and the second skill control update the display of icons of transformed skills. In some embodiments, an icon of a skill corresponding to a next used skill point is displayed, so that the user knows what a next triggered skill is. In some embodiments, the next used skill point refers to a skill point that is determined based on default logic (a predetermined order) and that is to be used next. In some other embodiments, if the user can select “a to-be-used skill point”, the next to-be-used skill point may be “a to-be-used skill point” selected by the user. Whether “a to-be-used skill point” is selected by the user is not limited in this application.

According to the technical solutions provided in the embodiments of this application, an icon of a skill corresponding to the next used skill point is displayed, so that the user may be effectively informed of the skill corresponding to the next skill point. This facilitates the user to select from the plurality of skill controls, which facilitates an arena operation, and facilitates the user to determine a skill to be controlled to cast by the virtual object based on an actual situation, thereby improving user experience.

In some embodiments, when the skill is casted by using the skill point, a cooldown of the skill is less than a rated cooldown of the skill.

The rated cooldown is equivalent to original cooldown of the skill, that is, a cooldown of the skill without participation of the skill point. In some embodiments, the rated cooldown of the skill group corresponding to the first skill control is 10s. When the user casts the skill by using the skill point, the cooldown time of the skill may be reduced to 2s. When the user uses the last skill point, for example, the last skill point corresponds to the third skill of the skill group that the user casts the first skill control, after the skill is consumed, the cooldown of the skill becomes the rated cooldown.

According to the technical solutions provided in the embodiments of this application, when the skill point is used to cast the skill, the cooldown of the skill is less than the rated cooldown of the skill. The cooldown (the cooldown time) of the skill may be shortened by using the skill point. In other words, it is convenient for the user to consecutively cast a plurality of skills within a short period of time through the skill control. In this case, connection between skills is better, user experience is better, and competition strength may be more manifested for a veteran user, thereby improving operation continuity.

According to the technical solutions provided in the embodiments of this application, it is supported that at least two skill controls share a same skill point set, and when a user performs an operation on a first skill control in the at least two skill controls, a target first skill point is determined from a skill point set, and the first virtual object is controlled to cast a skill corresponding to the first skill point in a skill group corresponding to the first skill control, so that a current skill corresponding to a currently triggered skill control is determined by a skill point. Therefore, when there are at least two skill points and at least two skill controls, there is a plurality of possible combinations of skill casting based on different skill point selections and different skill control selections, so that combinations of skill casting may be diversified, thereby improving combination flexibility and diversity of skill casting.

In addition, by using the technical solutions provided in the embodiments of this application, only the number of skills in the skill group or the number of skill points in the skill point set needs to be adjusted, so that the combination diversity of skill casting may be improved without adding a redundant entity (such as a skill control), thereby improving scalability of the technical solutions provided in the embodiments of this application. In addition, by using the technical solutions provided in the embodiments of this application, the user interface may also be optimized, for example, by using the skill point to reduce the number of skill controls, thereby helping improve utilization of the user interface.

FIG. 11 is a flowchart of a method for controlling a virtual object according to another embodiment of this application. An execution body of each operation of the method may be the terminal device 10 in the implementation environment shown in FIG. 1. For example, the execution body of each operation may be the client of the target application. In the following method embodiments, for ease of description, the description is provided by merely using a “client” as the execution entity of each operation. The method may include at least one operation in the following operations (1101 to 1103):

Operation 1101: Display, in a user interface, at least two skill controls sharing a same skill point set. The skill point set includes at least two skill points, and each skill control corresponding to one skill group, each skill group including at least one skill.

Operation 1101 and operation 1103 are the same as those described in the foregoing embodiments. For content not described in the embodiments of this application, reference may be made to the foregoing embodiments. Details are not described herein again.

Operation 1102: Determine a skill point selected through a skill point selection operation from the at least two skill points as the first skill point in response to an operation on the first skill control in the at least two skill controls. The skill point selection operation is an operation performed by the user for selecting the skill point.

A type of the skill point selection operation is not limited in this embodiment of this application, and the skill point selection operation may be at least one of slide, tap, or double-tap.

In some embodiments, the skill point selection operation and the operation on the first skill control are each a one-step slide operation. The one-step slide operation refers to one continuous slide operation, that is, a slide operation in which an initial position and an end position are clear, and the initial position is brought to the end position in one step.

In some embodiments, a skill control corresponding to a start position of the one-step slide operation is the first skill control, and a skill point corresponding to an end position of the one-step slide operation is the first skill point. For example, a skill control 1 and a skill control 2, and a skill point 1 and a skill point 2 are displayed in the user interface. In response to a one-step slide operation from the skill control 1 to the skill point 1, the client determines the skill control 1 as the first skill control, and determines the skill point 1 as the first skill point.

Alternatively, a skill point corresponding to a start position of the one-step slide operation is the first skill point, and a skill control corresponding to an end position of the one-step slide operation is the first skill control. For example, the skill control 1 and the skill control 2, and the skill point 1 and the skill point 2 are displayed in the user interface. In response to a one-step slide operation from the skill point 1 to the skill control 1, the client determines the skill control 1 as the first skill control, and determines the skill point 1 as the first skill point.

According to an aspect, the skill point may be slid from the first skill control to the skill point, and according to another aspect, the skill point may be slid from the skill point to the skill control. Both manners may be configured for selecting a skill point corresponding to a current operation. After the skill point is determined, a current skill in a skill group corresponding to the skill control may be determined based on the used skill point.

In some embodiments, the skill control may be tapped to select a skill and the skill point may be tapped to select a skill point to implement an objective of selecting which skill point. However, in this way, efficiency of operation is low, and efficiency of skill casting is affected. Even for a high-level player to try to tap with two fingers at the same time, there is a high requirement for the operation. Differently, in the technical solutions provided in the embodiments of this application, only one-step slide operation is required to complete selection of the skill and the skill point, which is very efficient, and has low operation difficulty.

Operation 1103: Control a first virtual object to cast a skill corresponding to the first skill point in a skill group corresponding to the first skill control.

In some embodiments, after the first skill point is determined, a skill currently corresponding to the first skill control is also determined accordingly. In this case, a trigger operation for the first skill control is equivalent to a trigger operation of the skill currently corresponding to the first skill control.

According to the technical solutions provided in the embodiments of this application, the skill point is arranged on the control layer, and the user can perform an operation on the skill point. After the user selects the skill point, the user performs an operation on the skill control, so that triggering of a skill corresponding to the skill point in a skill group may be implemented. The different skill points correspond to different skills in the skill group. Therefore, when the user can select a corresponding skill point, the skill in the skill group may be selectively cast. The user may choose to use different skill points based on an ever-changing situation. For the novice user, it may be relatively difficult to select a skill point one more step, but on the contrary, for the veteran user, the skill point is selected in advance, which can better reflect a reaction speed and arena strength of the user. In addition, the skill point selection operation can make the user clear of a skill that needs to be controlled to be cast by the virtual object, and is convenient for the user to select different skills based on a game situation. According to the technical solutions provided in the embodiments of this application, there is no fixed use order of the skill point, and use of the skill point depends on the skill point selection operation of the user, which enriches manners of controlling the virtual object, and improves fun and challenge of the arena game.

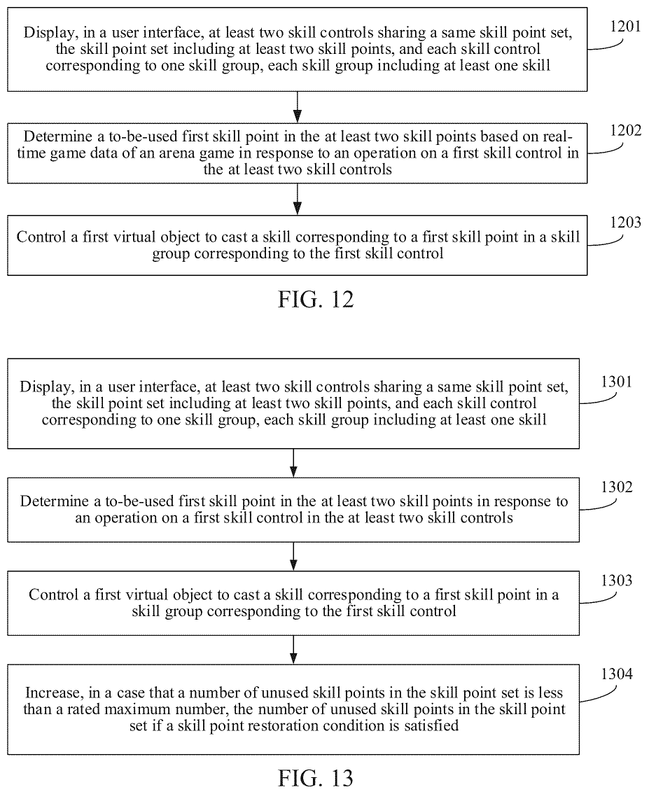

FIG. 12 is a flowchart of a method for controlling a virtual object according to another embodiment of this application. An execution body of each operation of the method may be the terminal device 10 in the implementation environment shown in FIG. 1. For example, the execution body of each operation may be the client of the target application. In the following method embodiments, for ease of description, the description is provided by merely using a “client” as the execution entity of each operation. The method may include at least one operation in the following operations (1201 to 1203):

Operation 1201: Display, in a user interface, at least two skill controls sharing a same skill point set. The skill point set includes at least two skill points, and each skill control corresponding to one skill group, each skill group including at least one skill.

Operation 1201 and operation 1203 are the same as those described in the foregoing embodiments. For content not described in the embodiments of this application, reference may be made to the foregoing embodiments. Details are not described herein again.

Operation 1202: Determine a target first skill point in at least two skill points based on real-time game data in response to an operation on a first skill control in the at least two skill controls.

The real-time game data may refer to real-time game data of the foregoing arena game, for example, real-time game data of the arena game in the MOBA game. The real-time game data may reflect a current progress status of the arena game in real time.

In some embodiments, the real-time game data includes at least one of the following: skills casted by the first virtual object for the last N times, attribute information of the first virtual object, attribute information of a second virtual object that the first virtual object is battling against, or attribute information of a third virtual object that the first virtual object is assisting, N being a positive integer. Precisely due to the variability of an arena game situation, determining the target first skill point from the at least two skill points based on real-time game data can improve rationality of determining the first skill point.

For example, the client may determine the target first skill point in the at least two skill points based on the skills cast by the first virtual object for the last N times. For example, the client determines a skill point preference of the first virtual object in the game based on a number of different skill points corresponding to skills cast by the first virtual object for the last N times. If the first virtual object prefers to use a skill in the skill group corresponding to the first skill point, the skill point that is preferred to be used is preferentially determined from the at least two skill points as the target first skill point.

For example, the client may determine the target first skill point in the at least two skill points based on attribute information of the first virtual object. In some embodiments, attributes of skills corresponding to different skill points are different. For example, the skill corresponding to the skill point 1 is the defense skill, and the skill corresponding to the skill point 2 is the attack skill. If attribute information of the first virtual object is blood volume information of the first virtual object, when a blood volume value of the first virtual object is low, the client may determine the skill point 1 in the at least two skill points as the target first skill point. In this case, the defense skill corresponding to the skill point 1 may improve a defense value of the first virtual object. In another example, the blood volume information of the first virtual object is very healthy, but the first virtual object is located at a dangerous position. For example, there are a plurality of second virtual objects around the first virtual object (the second virtual object herein is a virtual object in a different camp from the first virtual object), the client determines the skill point 2 in the at least two skill points as the target first skill point. In this case, the attack skill corresponding to the skill point 2 may improve an attack value of the first virtual object. In another example, the attribute information of the first virtual object may alternatively be an attribute gain possessed by the first virtual object. For example, the first virtual object itself has an attribute gain of attack. In this case, defense power needs to be improved, and the client determines the skill point 1 in the at least two skill points as the target first skill point. In this case, the defense skill corresponding to the skill point 1 may improve the defense value of the first virtual object. In another example, the first virtual object itself has an attribute gain of defense. In this case, attack power needs to be improved, and the client determines the skill point 2 in the at least two skill points as the target first skill point. In this case, the attack skill corresponding to the skill point 2 may improve the attack value of the first virtual object, so that complementation between the skill and the attribute gain may be achieved.

For example, the client may determine the target first skill point in the at least two skill points based on attribute information of the second virtual object that the first virtual object is battling against. For example, the client determines the target first skill point in the at least two skill points based on the blood volume value, the attack value, the defense value, and the like of the second virtual object.

For example, the client may determine the target first skill point in the at least two skill points based on attribute information of the third virtual object that the first virtual object is assisting. For example, the third virtual object is a virtual object in the same camp as the first virtual object. The client may determine the target first skill point in the at least two skill points based on the blood volume value, the attack value, the defense value, and the like of the third virtual object.

Operation 1203: Control a first virtual object to cast a skill corresponding to the first skill point in a skill group corresponding to the first skill control.

According to the technical solutions provided in the embodiments of this application, the target first skill point is determined based on the real-time game data, so that a requirement of the user can be more satisfied, and a selection operation on the skill point may be avoided, which is very friendly to the novice user, thereby improving arena experience of the user.

FIG. 13 is a flowchart of a method for controlling a virtual object according to another embodiment of this application. An execution body of each operation of the method may be the terminal device 10 in the implementation environment shown in FIG. 1. For example, the execution body of each operation may be the client of the target application. In the following method embodiments, for case of description, the description is provided by merely using a “client” as the execution entity of each operation. The method may include at least one operation in the following operations (1301 to 1304):

Operation 1301: Display, in a user interface, at least two skill controls sharing a same skill point set. The skill point set includes at least two skill points, and each skill control corresponding to one skill group, each skill group including at least one skill.

Operation 1302: Determine a target first skill point in at least two skill points in response to an operation on a first skill control in the at least two skill controls.

Operation 1303: Control a first virtual object to cast a skill corresponding to the first skill point in a skill group corresponding to the first skill control.

Operation 1301 to operation 1303 are the same as those described in the foregoing embodiments. For content not described in the embodiments of this application, reference may be made to the foregoing embodiments. Details are not described herein again.

Operation 1304: Increase, when a number of unused skill points in the skill point set is less than a rated maximum number, the number of unused skill points in the skill point set if a skill point restoration condition is satisfied.

The rated maximum number refers to a maximum number of skill points that can be included in the skill point set, and may be set and adjusted based on an actual use requirement. The skill point restoration condition is configured for indicating whether the skill point can be restored.

In some embodiments, the unused skill point in the skill point set can be restored to the rated maximum number. For example, the rated maximum number is 3. If a number of unused skill points in the skill point set is less than 3, the client determines whether a restoration condition is satisfied, and when the restoration condition is satisfied, the skill point is restored to the rated maximum number.

A manner of increasing the number of unused skill points in the skill point set is not limited in this embodiment of this application, and the number of unused skill points in the skill point set may be increased to the rated maximum number at a time, or may be increased to the rated maximum number of skill points one by one.

In some embodiments, the skill point restoration condition includes at least one of the following: first duration is reached since a skill point is used last time, second duration is reached since a skill point is restored last time, the first virtual object causes damage satisfying a first condition to an enemy virtual object, a camp to which the first virtual object belongs causes damage satisfying a second condition to an enemy virtual object, the first virtual object obtains a first gain effect, or the camp to which the first virtual object belongs obtains a second gain effect.

In some embodiments, the number of skill points in the skill point set is restored to the rated maximum number at the beginning of the arena game.

In some embodiments, the skill point restoration condition is first duration since a skill point is used last time. For example, the first duration is 10s. 10s after the last use of the skill point, the user does not use the skill point again. In this case, the number of skill points is restored to the rated maximum number.

In some embodiments, the skill point restoration condition is second duration since a skill point is restored last time. For example, the second duration is 60s. After the skill point is restored from the last time, the number of skill points is automatically restored to the rated maximum number by 60s.

In some embodiments, the skill point restoration condition is that the first virtual object causes damage satisfying a first condition to the enemy virtual object. In some embodiments, the first condition is that damage caused by the first virtual object to the enemy virtual object is greater than a first damage threshold, or a number of the enemy virtual objects that the first virtual object defeats is greater than a first number threshold. If the first condition is satisfied, the number of skill points is restored to the rated maximum number. For example, the first number threshold is 5. If the number of the enemy virtual objects that the first virtual object defeats is greater than 5, the number of skill points is restored to the rated maximum number.

In some embodiments, the skill point restoration condition is that a camp to which the first virtual object belongs causes damage satisfying a second condition to the enemy virtual object. In some embodiments, the second condition is that damage caused by the camp to which the first virtual object belongs to the enemy virtual object is greater than a second damage threshold, or a number of enemy virtual objects defeated by the camp to which the first virtual object belongs is greater than a second number threshold. If the second condition is satisfied, the number of skill points is restored to the rated maximum number. For example, the second number threshold is 5. If the number of enemy virtual objects defeated by the camp to which the first virtual object belongs is greater than 5, the number of skill points is restored to the rated maximum number.

In some embodiments, the skill point restoration condition is that the first virtual object obtains the first gain effect. In some embodiments, the first gain effect is at least one of an attack effect or a defense effect. This is not limited in this embodiment of this application. For example, if the first gain effect is the attack effect, when the first virtual object obtains the attack effect, the number of skill points is restored to the rated maximum number.

In some embodiments, the skill point restoration condition is that the camp to which the first virtual object belongs obtains the second gain effect. In some embodiments, the second gain effect is at least one of the attack effect or the defense effect. This is not limited in this embodiment of this application. For example, if the second gain effect is the defense effect, when the first virtual object obtains the defense effect, the number of skill points is restored to the rated maximum number.

According to the technical solutions provided in the embodiments of this application, when the number of unused skill points in the skill point set is less than the rated maximum number, the number of unused skill points in the skill point set is increased if the skill point restoration condition is satisfied. In addition, the skill point restoration condition is diverse. Based on different requirements, the user may set different skill point restoration modes. In addition, rapid skill point restoration is also beneficial to speeding up progress of the game and reducing processing overheads of the device.

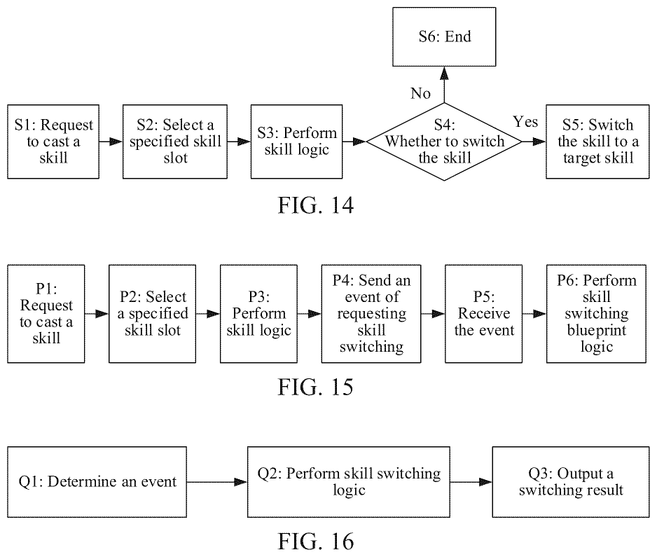

FIG. 14 is a block diagram of a method for controlling a virtual object according to an embodiment in the related art. The method may include at least one operation in the following operations (S1 to S6):

Operation S1: Request to cast a skill.

The server requests the client of the terminal device to cast the skill. After receiving a skill cast request, the client performs operation S2 to operation S3, to cast skill logic of the selected specified skill slot.

Operation S2: Select a specified skill slot.

The skill slot in this embodiment of this application may also be considered as a skill control.

Operation S3: Perform skill logic.

After logic is executed, the client checks whether the skill needs to be switched to another skill. If switching needs to be performed, the client may perform switching on a specific skill object in the skill slot to ensure different skill logics during next casting.

Operation S4: Whether to switch the skill.

If yes, perform operation S5, or if not, perform operation S6.

Operation S5: Switch the skill to a target skill. The target skill may be a next

skill of a current skill in the specified skill slot.

Operation S6: End.

The skill casting logic in the related art has a problem that a target skill needs to be clear and an order of skill casting needs to be fixed. However, the order of skill casting is not limited in the technical solutions provided in the embodiments of this application. In the presence of skill points, skills may be randomly combined. The order of skill casting is not limited, which enriches manners in which the virtual object casts the skill.

FIG. 15 is a block diagram of a method for controlling a virtual object according to an embodiment of this application. An execution body of each operation of the method may be the terminal device 10 in the implementation environment shown in FIG. 1. For example, the execution body of each operation may be the client of the target application. In the following method embodiments, for ease of description, the description is provided by merely using a “client” as the execution entity of each operation. The method may include at least one operation in the following operations (P1 to P6):

Operation P1: Request to cast a skill.

Operation P2: Select a specified skill slot.

Operation P3: Perform skill logic.

Operation P4: Send a skill switching event.

Operation P5: Receive the event.

Operation P6: Perform skill switching logic.

The skill switching logic provided in the embodiments of this application is a function of switching different logics based on a specific situation. To be specific, after the skill point is used (or skill logic of a skill is executed), the client may directly switch skills corresponding to skill controls. Therefore, skill switching logic needs to be scripted and configured. Specific skill switching logic simply checks whether a skill needs to be switched from before to detect whether a condition is satisfied, and skills of each specified skill slot in the user interface are switched at the same time.

FIG. 16 is a block diagram of a method for controlling a virtual object according to another embodiment of this application. An execution body of each operation of the method may be the terminal device 10 in the implementation environment shown in FIG. 1. For example, the execution body of each operation may be the client of the target application. In the following method embodiments, for ease of description, the description is provided by merely using a “client” as the execution entity of each operation. The method may include at least one operation in the following operations (Q1 to Q3):

Operation Q1: Determine an event.

In some embodiments, which specific skill point that is the currently used in the skill point set is determined through operation Q1.

Operation Q2: Perform skill switching logic.

Skill switching logic is performed based on the determined skill point, that is, a skill corresponding to the skill control is switched to a skill corresponding to the current skill point.

Operation Q3: Output a switching result.

According to the technical solutions provided in the embodiments of this application, skill switching logic may be configured, and different virtual objects may adjust specific content of the skill switching logic in different situations.

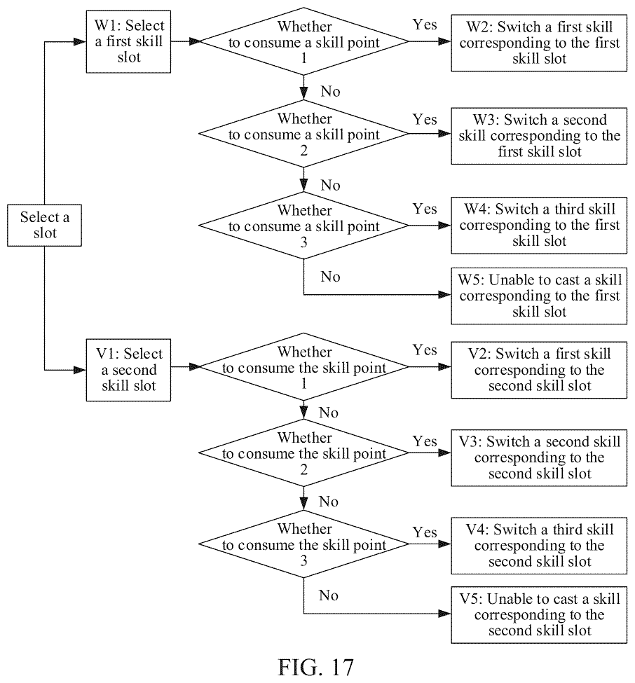

FIG. 17 is a block diagram of skill switching logic according to an embodiment of this application. An execution body of each operation of the method may be the terminal device 10 in the implementation environment shown in FIG. 1. For example, the execution body of each operation may be the client of the target application. In the following method embodiments, for ease of description, the description is provided by merely using a “client” as the execution entity of each operation. The method may include at least one operation in the following operations (W1 to V5):

Operation W1: Select a first skill slot.

It is determined whether to consume the skill point 1. If yes, perform operation W2, or if not, it is determined whether to consume the skill point 2.

In this embodiment of this application, using the skill point may also be considered as consuming the skill point.

Operation W2: Switch a first skill corresponding to the first skill slot.

It is determined whether to consume the skill point 2. If yes, perform operation W3, or if not, it is determined whether to consume the skill point 3.

Operation W3: Switch a second skill corresponding to the first skill slot.

It is determined whether to consume the skill point 3. If yes, perform operation W4, or if not, perform operation W5.

Operation W4: Switch a third skill corresponding to the first skill slot.

Operation W5: Unable to cast a skill corresponding to the first skill slot.

Operation V1: Select a second skill slot.

It is determined whether to consume the skill point 1. If yes, perform operation V2, or if not, it is determined whether to consume the skill point 2.

Operation V2: Switch a first skill corresponding to the second skill slot.

It is determined whether to consume the skill point 2. If yes, perform operation V3, or if not, it is determined whether to consume the skill point 3.

Operation V3: Switch a second skill corresponding to the second skill slot.

It is determined whether to consume the skill point 3. If yes, perform operation V4, or if not, perform operation V5.

Operation V4: Switch a third skill corresponding to the second skill slot.

Operation V5: Unable to cast a skill corresponding to the second skill slot.

According to the technical solutions provided in the embodiments of this application, different skill points are numbered to design different skills corresponding to different skills, and a new skill switching logic is provided, so that a skill that needs to be switched can be determined based on a used skill point. In other words, the current skill point is consumed, and the skill corresponding to the skill slot needs to be updated to a skill corresponding to a next skill point.

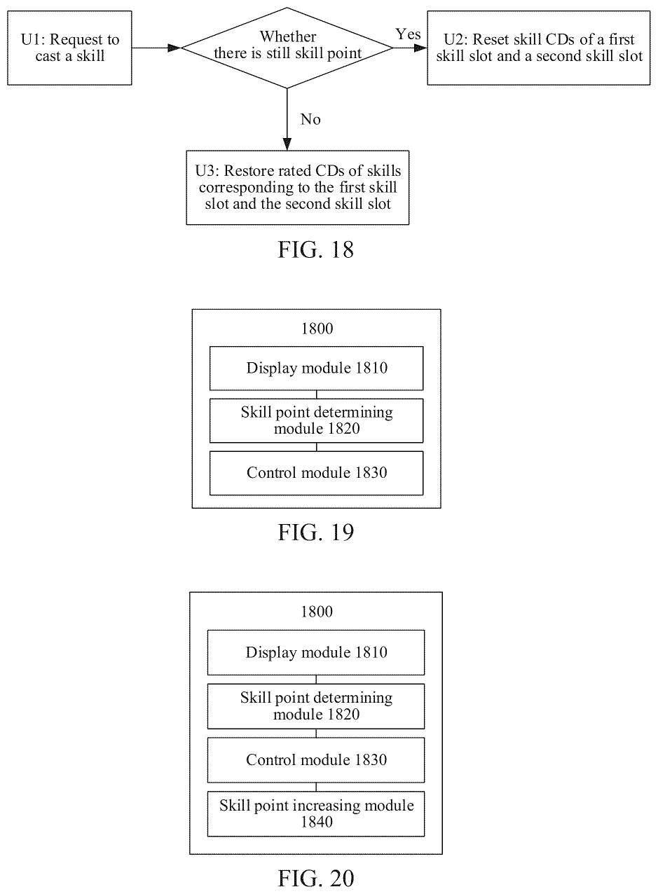

FIG. 18 is a block diagram of CD skill switching logic according to an embodiment of this application. An execution body of each operation of the method may be the terminal device 10 in the implementation environment shown in FIG. 1. For example, the execution body of each operation may be the client of the target application. In the following method embodiments, for ease of description, the description is provided by merely using a “client” as the execution entity of each operation. The method may include at least one operation in the following operations (U1 to U3):

Operation U1: Request to cast a skill.

After the skill is cast, it is determined whether there is still skill point. If yes, perform operation U2, if not, perform operation U3.

After the skill is casted for each time, it is detected whether there is skill point in the skill point set. If there is skill point, the casted skill does not enter a complete CD (rated CD) of the skill.

Operation U2: Reset skill CDs of a first skill slot and a second skill slot.

In some embodiments, the skill CDs corresponding to all slots are adjusted to 0, or to less than the rated CD.

Operation U3: Restore rated CDs of skills corresponding to the first skill slot and the second skill slot.

The following is an apparatus embodiment of this application, which can be used to perform the method embodiments of this application. For details not disclosed in the apparatus embodiments of this application, reference is made to the method embodiments of this application.

FIG. 19 is a block diagram of a virtual object control apparatus according to an embodiment of this application. The apparatus has a function of implementing the foregoing method example, and the function may be implemented by hardware or by hardware executing corresponding software. The apparatus may be the terminal device described above, or may be disposed in a terminal device. As shown in FIG. 19, the apparatus 1800 may include: a display module 1810, a skill point determining module 1820, and a control module 1830.

The display module 1810, configured to display at least two skill controls sharing a same skill point set in a user interface, the skill point set including at least two skill points, each skill control corresponding to one skill group, and each skill group including at least one skill.

The skill point determining module 1820, configured to determine a target first skill point in the at least two skill points in response to an operation on a first skill control in the at least two skill controls.

The control module 1830, configured to control a first virtual object to cast a skill corresponding to the first skill point in the skill group corresponding to the first skill control.

In some embodiments, a first skill group in skill groups corresponding to the at least two skill controls includes at least two skills, and different skills included in the first skill group correspond to different skill points.

In some embodiments, the display module 1810 is further configured to display an unused skill point in the at least two skill points.

In some embodiments, the display module 1810 is further configured to display an icon of a skill corresponding to a next used skill point in a display region of the skill control.

In some embodiments, the skill point determining module 1820 is configured to determine the target first skill point in the at least two skill points based on a skill point use order use order, the skill point use order being configured to define a use order of the at least two skill points.

In some embodiments, the skill point determining module 1820 is configured to determine a skill point selected through a skill point selection operation from the at least two skill points as the first skill point, the skill point selection operation being an operation performed by a user for selecting a skill point.

In some embodiments, the skill point selection operation and the operation on the first skill control are each a one-step slide operation, a skill control corresponding to a start position of the one-step slide operation being the first skill control, and a skill point corresponding to an end position of the one-step slide operation being the first skill point; or a skill point corresponding to a start position of the one-step slide operation being the first skill point, and a skill control corresponding to an end position of the one-step slide operation being the first skill control.

In some embodiments, the skill point determining module 1820 is configured to determine the target first skill point in the at least two skill points based on real-time game data, the real-time game data including at least one of the following: skills casted by the first virtual object for the last N times, attribute information of the first virtual object, attribute information of a second virtual object that the first virtual object is battling against, or attribute information of a third virtual object that the first virtual object is assisting, N being a positive integer.

In some embodiments, when the skill is casted by using the skill point, a cooldown of the skill is less than a rated cooldown of the skill.

In some embodiments, as shown in FIG. 20, the apparatus further includes a skill point increasing module 1840.

The skill point increasing module 1840, configured to increase, when a number of unused skill points in the skill point set is less than a rated maximum number, the number of unused skill points in the skill point set if a skill point restoration condition is satisfied, the skill point restoration condition including at least one of the following: first duration is reached since a skill point is used last time, second duration is reached since a skill point is restored last time, the first virtual object causes damage satisfying a first condition to an enemy virtual object, a camp to which the first virtual object belongs causes damage satisfying a second condition to an enemy virtual object, the first virtual object obtains a first gain effect, or the camp to which the first virtual object belongs obtains a second gain effect.

According to the technical solutions provided in the embodiments of this application, it is supported that at least two skill controls share a same skill point set, and when a user performs an operation on a first skill control in the at least two skill controls, a target first skill point is determined from a skill point set, and the first virtual object is controlled to cast a skill corresponding to the first skill point in a skill group corresponding to the first skill control, so that a current skill corresponding to a currently triggered skill control is determined by a skill point. Therefore, when there are at least two skill points and at least two skill controls, there is a plurality of possible combinations of skill casting based on different skill point selections and different skill control selections, so that combinations of skill casting may be diversified, thereby improving combination flexibility and diversity of skill casting.

In addition, by using the technical solutions provided in the embodiments of this application, only the number of skills in the skill group or the number of skill points in the skill point set needs to be adjusted, so that the combination diversity of skill casting may be improved without adding a redundant entity (such as a skill control), thereby improving scalability of the technical solutions provided in the embodiments of this application. In addition, by using the technical solutions provided in the embodiments of this application, the user interface may also be optimized, for example, by using the skill point to reduce the number of skill controls, thereby helping improve utilization of the user interface.

When the apparatus provided in the foregoing embodiments implements functions of the apparatus, the division of the foregoing functional modules is merely an example for description. During actual application, the foregoing function allocation is completed by different functional modules according to needs, that is, the internal structure of the device is divided into different functional modules, to complete all or some of functions described above. In addition, the apparatus and method embodiments provided in the foregoing embodiments belong to the same conception. For the specific implementation process, reference may be made to the method embodiments, and details are not described herein again.

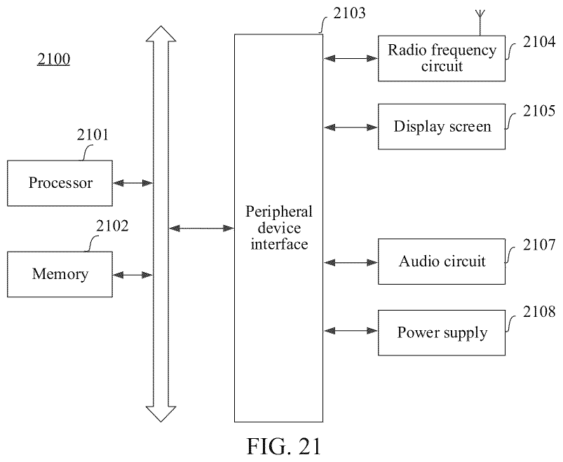

FIG. 21 is a structural block diagram of a terminal device 2100 according to an embodiment of this application. The terminal device 2100 may be the terminal device 10 in the implementation environment shown in FIG. 1, and is configured to perform the method for controlling a virtual object provided in the foregoing embodiments. Specifically,
generally, the terminal device 2100 includes: a processor 2101 and a memory 2102.

The processor 2101 may include one or more processing cores, such as a 4-core processor or an 8-core processor. The processor 2101 may be implemented by using at least one hardware form of a digital signal processor (DSP), a field programmable gate array (FPGA), and a programmable logic array (PLA). The processor 2101 may also include a main processor and a coprocessor. The main processor is a processor configured to process data in an active state, also referred to as a central processing unit (CPU). The coprocessor is a low-power consumption processor configured to process data in a standby state. In some embodiments, the processor 2101 may be integrated with a graphics processing unit (GPU). The GPU is configured to be responsible for rendering and drawing content that needs to be displayed in a display. In some embodiments, the processor 2101 may alternatively include an artificial intelligence (AI) processor. The AI processor is configured to process a computing operation related to machine learning.

The memory 2102 may include one or more computer-readable storage media. The computer-readable storage media may be non-transitory. The memory 2102 may alternatively include a high-speed random access memory and a non-volatile memory, for example, one or more disk storage devices and flash storage devices. In some embodiments, the non-transitory computer-readable storage medium in the memory 2102 is configured to store a computer program, the computer program being configured to be executed by one or more processors to implement the foregoing method for controlling a virtual object.

In some embodiments, the terminal device 2100 further includes: a peripheral device interface 2103 and at least one peripheral device. The processor 2101, the memory 2102, and the peripheral device interface 2103 may be connected through a bus or a signal cable. Each peripheral device may be connected to the peripheral device interface 2103 through a bus, a signal cable, or a circuit board. Specifically, the peripheral device includes: at least one of a radio frequency circuit 2104, a display screen 2105, an audio circuit 2107, or a power supply 2108.

A person skilled in the art may understand that the structure shown in FIG. 21 constitutes no limitation to the terminal device 2100, and the terminal device may include more or fewer components than those shown in the figure, or some components may be combined, or a different component arrangement may be used.

In an exemplary embodiment, a non-transitory computer-readable storage medium is further provided, having a computer program stored therein, and the computer program being executed by a processor to implement the foregoing method for controlling a virtual object.

In some embodiments, the computer-readable storage medium may include: a read-only memory (ROM), a random access memory (RAM), a solid state drives (SSD), an optical disc, or the like. The RAM may include a resistance random access memory (ReRAM) and a dynamic random access memory (DRAM).

In an exemplary embodiment, a computer program product is further provided, the computer program product including a computer program, the computer program being stored in a computer-readable storage medium. A processor of a terminal device reads the computer program from the computer-readable storage medium, and executes the computer program, to cause the terminal device to perform the foregoing method for controlling a virtual object.

According to the embodiments of this application, a prompt interface or a pop-up window may be displayed, or voice prompt information may be outputted before and during collecting user-related data of a user. The prompt interface, the pop-up window, or the voice prompt information is used for prompting the user that data related to the user is currently being collected, so that this application only starts to perform related operations of obtaining the user-related data after obtaining a confirmation operation of the user for the prompt interface or the pop-up window, otherwise (that is, when the confirmation operation of the user for the prompt interface or the pop-up window is not obtained), ends the related operations of obtaining the user-related data, that is, skips obtaining the user-related data. In other words, all user data collected by this application is processed strictly in accordance with the requirements of relevant national laws and regulations. The informed consent or separate consent of a personal information subject is collected with the consent and authorization of the user, subsequent data use and processing activities are carried out within the scope of laws, regulations and the authorization of the personal information subject, and the collection, use and processing of user-related data need to comply with relevant laws, regulations and standards of relevant countries and regions. For example, the operation, the user interface, the virtual environment, the virtual object, and the like involved in this application are all obtained with full authorization.

“A plurality of” mentioned in this specification refers to two or more. “And/or” describes an association relationship between associated objects and represents that three relationships may exist. For example, A and/or B may represent the following three cases: Only A exists, both A and B exist, and only B exists. The character “/” generally represents an “or” relationship between the associated objects. In addition, the operation numbers described in this specification merely schematically show a possible execution sequence of the operations. In some other embodiments, the operations may not be performed based on the number sequence. For example, two operations with different numbers may be performed simultaneously, or two operations with different numbers may be performed based on a sequence contrary to the sequence shown in the figure. This is not limited in the embodiments of this application.

The foregoing descriptions are merely exemplary embodiments of this application, but are not intended to limit this application. Any modification, equivalent replacement, or improvement made within the spirit and principle of this application shall fall within the protection scope of this application.

What is claimed is:

1. A method for controlling a virtual object performed by a terminal device, the method comprising:
displaying at least two skill controls sharing a same skill point set, the skill point set comprising at least two skill points, and each skill control corresponding to one skill group, each skill group comprising at least one skill;
determining a target first skill point in the at least two skill points in response to an operation on a first skill control of the at least two skill controls; and
controlling a first virtual object to cast a skill corresponding to the first skill point in the skill group corresponding to the first skill control.

2. The method according to claim 1, wherein a first skill group corresponding to the at least two skill controls comprises at least two skills, and different skills comprised in the first skill group correspond to different skill points.

3. The method according to claim 1, further comprising:
displaying an unused skill point in the at least two skill points.

4. The method according to claim 1, further comprising:
displaying an icon of a skill corresponding to a next used skill point in a display region of the skill control.

5. The method according to claim 1, wherein the determining a target first skill point in the at least two skill points comprises:
determining the target first skill point in the at least two skill points based on a skill point use order, the skill point use order being configured to define a use order of the at least two skill points.

6. The method according to claim 1, wherein the determining a target first skill point in the at least two skill points comprises:
determining a skill point selected through a skill point selection operation from the at least two skill points as the first skill point, the skill point selection operation being an operation performed by a user for selecting a skill point.

7. The method according to claim 6, wherein the skill point selection operation and the operation on the first skill control are each a one-step slide operation,
a skill control corresponding to a start position of the one-step slide operation being the first skill control, and a skill point corresponding to an end position of the one-step slide operation being the first skill point; and
a skill point corresponding to a start position of the one-step slide operation being the first skill point, and a skill control corresponding to an end position of the one-step slide operation being the first skill control.

8. The method according to claim 1, wherein the determining a target first skill point in the at least two skill points comprises:
determining the target first skill point in the at least two skill points based on real-time game data,
the real-time game data comprising at least one of the following: skills casted by the first virtual object for the last N times, attribute information of the first virtual object, attribute information of a second virtual object that the first virtual object is battling against, or attribute information of a third virtual object that the first virtual object is assisting, N being a positive integer.

9. The method according to claim 1, wherein when the skill is casted by using the skill point, a cooldown of the skill is less than a rated cooldown of the skill.

10. The method according to claim 1, further comprising:
when a number of unused skill points in the skill point set is less than a rated maximum number, increasing the number of unused skill points in the skill point set if a skill point restoration condition is satisfied, the skill point restoration condition comprising at least one of the following: first duration is reached since a skill point is used last time, second duration is reached since a skill point is restored last time, the first virtual object causes damage satisfying a first condition to an enemy virtual object, a camp to which the first virtual object belongs causes damage satisfying a second condition to an enemy virtual object, the first virtual object obtains a first gain effect, or the camp to which the first virtual object belongs obtains a second gain effect.

11. A computer device, comprising a processor and a memory, the memory having a computer program stored therein, the computer program, when executed by the processor, causing the computer device to implement a method for controlling a virtual object including:
displaying at least two skill controls sharing a same skill point set, the skill point set comprising at least two skill points, and each skill control corresponding to one skill group, each skill group comprising at least one skill;
determining a target first skill point in the at least two skill points in response to an operation on a first skill control of the at least two skill controls; and
controlling a first virtual object to cast a skill corresponding to the first skill point in the skill group corresponding to the first skill control.

12. The computer device according to claim 11, wherein a first skill group corresponding to the at least two skill controls comprises at least two skills, and different skills comprised in the first skill group correspond to different skill points.

13. The computer device according to claim 11, wherein the method further comprises:
displaying an unused skill point in the at least two skill points.

14. The computer device according to claim 11, wherein the method further comprises:
displaying an icon of a skill corresponding to a next used skill point in a display region of the skill control.

15. The computer device according to claim 11, wherein the determining a target first skill point in the at least two skill points comprises:
determining the target first skill point in the at least two skill points based on a skill point use order, the skill point use order being configured to define a use order of the at least two skill points.

16. The computer device according to claim 11, wherein the determining a target first skill point in the at least two skill points comprises:
determining a skill point selected through a skill point selection operation from the at least two skill points as the first skill point, the skill point selection operation being an operation performed by a user for selecting a skill point.

17. The computer device according to claim 11, wherein the determining a target first skill point in the at least two skill points comprises:
determining the target first skill point in the at least two skill points based on real-time game data,
the real-time game data comprising at least one of the following: skills casted by the first virtual object for the last N times, attribute information of the first virtual object, attribute information of a second virtual object that the first virtual object is battling against, or attribute information of a third virtual object that the first virtual object is assisting, N being a positive integer.

18. The computer device according to claim 11, wherein when the skill is casted by using the skill point, a cooldown of the skill is less than a rated cooldown of the skill.

19. The computer device according to claim 11, wherein the method further comprises:
when a number of unused skill points in the skill point set is less than a rated maximum number, increasing the number of unused skill points in the skill point set if a skill point restoration condition is satisfied, the skill point restoration condition comprising at least one of the following: first duration is reached since a skill point is used last time, second duration is reached since a skill point is restored last time, the first virtual object causes damage satisfying a first condition to an enemy virtual object, a camp to which the first virtual object belongs causes damage satisfying a second condition to an enemy virtual object, the first virtual object obtains a first gain effect, or the camp to which the first virtual object belongs obtains a second gain effect.

20. A non-transitory computer-readable storage medium having a computer program stored therein, and the computer program, when executed by a processor of a computer device, causing the computer device to perform a method for controlling a virtual object including:
displaying at least two skill controls sharing a same skill point set, the skill point set comprising at least two skill points, and each skill control corresponding to one skill group, each skill group comprising at least one skill;
determining a target first skill point in the at least two skill points in response to an operation on a first skill control of the at least two skill controls; and
controlling a first virtual object to cast a skill corresponding to the first skill point in the skill group corresponding to the first skill control.
